(19) United States
(12) Patent Application Publication
(10) Pub. No.: US 2007/0087239 A1
(43) Pub. Date: Apr. 19, 2007

(54) Fuel cell fluid management system

(75) Inventors: Alan John Mulvenna, North Vancouver (CA); Theodore Douglas Yntema, Vancouver (CA); Curtis Michael Robin, Vancouver (CA); Gerhard Michael Schmidt, Vancouver (CA); James Gah-Ming Ko, Vancouver (CA); Sonja Elisabeth Macfarlane, Vancouver (CA)

Correspondence Address: GOWLING LAFLEUR HENDERSON LLP, P.O. BOX 49122, 2300-1055 DUNSMUIR ST., VANCOUVER, BC, V7X 1J1, CA

(73) Assignee: General Hydrogen Corporation

(21) Appl. No.: 11/251,792

(22) Filed: Oct. 18, 2005

(51) Int. Cl. H01M 8/04

(52) U.S. Cl. 429/26; 429/38; 429/13

(57) ABSTRACT

A fuel cell fluid management system that transfers water vapor from a fuel cell stack's oxidant exhaust to the fuel cell stack's fluid supplies through membrane tubes; that coalesces and separates liquid water from the fuel cell's fluid exhaust streams for removal to the environment; that transfers heat from the fuel cell stack to the fluid supplies, and that disposes of purged fuel cell fuel. The fluid management system is shaped to close couple to the fluid ports of a corresponding fuel cell stack.

### TECHNICAL FIELD

The present invention relates generally to fluid management systems for fuel cells.

### BACKGROUND OF THE INVENTION

Fuel cells produce electricity from the electrochemical reaction between a hydrogen-containing fuel and oxygen. Fuel cell exhaust consists of oxidant and water and some waste heat, provided that pure hydrogen is used.

One type of fuel cell is a proton-exchange-membrane (PEM) fuel cell. PEM fuel cells are typically combined into fuel cell stacks to provide a greater voltage than can be generated by a single fuel cell. Fuel cell stacks are typically provided with manifolds that distribute fluid to and collect fluid from all of the constituent fuel cells. The manifolds are provided with ports for coupling to external fluid supply circuits, external fluid exhaust circuits and external fluid circulating circuits.

The fuel used by a PEM fuel cell is typically a gaseous fuel, and the gaseous fuel is typically hydrogen, but may be another hydrogen-containing fuel, such as reformate. In a typical PEM fuel cell, a chamber of hydrogen gas is separated from a chamber of oxidant gas by a proton-conductive membrane that is impermeable to oxidant gases. The membrane is typically formed of NAFION® polymer manufactured by DuPont or some similar ion-conductive polymer. NAFION polymer is highly selectively permeable to water when exposed to gases.

In order for the fuel cell membrane to function properly, it must be hydrated; in typical PEM fuel cells, water vapor is continuously added to the fuel supply stream and to the oxidant supply stream in order to keep the fuel cell membranes hydrated. Fuel cells release more water in their exhaust than they require in their fuel, as hydrogen atoms and oxygen atoms combine to produce water in the electrochemical reaction of the fuel cell. As water permeates very readily through the membrane separating the fuel and the oxidant, sufficient water can return from the oxidant side of the membrane to the fuel side by simple permeation as long as the high water concentration on the oxidant side is maintained.

Fuel cells often operate using air as the oxidant, relying upon the approximately 20% oxygen in ambient air. The use of air as an oxygen source requires a flow rate of air five times that required for oxygen. When ambient air is used as an oxygen source, this high flow rate dries out the membrane by diluting the water vapor concentration on the oxidant exhaust side of the membrane. If water can be recovered from the oxidant exhaust, the need for a separate water supply to keep the membrane hydrated for proper permeation of hydrogen can theoretically be eliminated.

US patent application 2002/0155328 to Smith describes a method and apparatus which recovers and recycles water from a fuel cell exhaust and returns the water to the supply gases for the fuel cells. Particularly, water vapor is transferred from the exhaust gases to one or more supply gases by passing hot humidified exhaust gas over water permeable tubes, such that a supply gas flowing through the tubes is humidified by water permeating through the tubes and heated by heat conducted through the tubes from the exhaust gas. Commonly assigned U.S. Pat. No. 6,864,005 to Mossman discloses and claims a membrane exchange humidifier, particularly for use in humidifying reactant streams for solid polymer electrolyte fuel cell systems.

A drawback of the described apparati in Smith and Mossman is that liquid water in one or both of the oxidant exhaust stream and the fuel exhaust stream is not separated and removed from the exhaust streams before reaching a membrane humidifier in the apparatus. The accumulation of liquid water within a membrane humidifier can clog the membrane, thereby reducing the effectiveness of the humidifier and the humidification method. When the effectiveness of the humidifier is reduced, the fuel cell supply gases may not be humidified to the level required for effective power generation in the fuel cells, and may lead to drying of the fuel cell membrane. Drying of the fuel cell membrane is associated with the creation of holes in the fuel cell membrane, a condition which may cause the fuel cell to stop producing electricity. Furthermore, liquid water in a recirculating fuel stream can harm fuel circulation pumps, which may lead to failure of the fuel circulation pump. The lack of liquid water removal in a humidification apparatus requires that a separate liquid water removal apparatus and method be employed in order to provide effective humidification of fuel cell supply gases, and in order to avoid damage to fuel circulation pumps.

A further drawback of the products disclosed in Smith and Mossman is that they require connecting apparati such as pipes or tubes between the fuel cell and the humidification apparatus. Connecting apparati result in heat loss, which may lead to the condensing of the water vapor to liquid water within the connecting apparati or within the humidification apparatus, thereby reducing the effectiveness of the humidification apparatus and method. Furthermore, the condensing of water vapor to liquid water within the humidification apparatus increases the amount of liquid water within a humidification apparatus and within a fuel circulation pump, and thereby exacerbates the problems described above. Furthermore, connecting apparati require space, which increases the volume of the system. Furthermore, connecting apparati increase the complexity of the fuel cell system, which may increase the cost of the system.

Commonly assigned U.S. Pat. Nos. 6,545,609 and 6,939,629 disclose and claim a humidification system for a fuel cell. In U.S. Pat. No. 6,545,609, Shimanuki et al., provide a humidification system for a fuel cell that includes a humidifier having a bundled plurality of tube type hollow thread members made of a water permeable membrane. The humidifier transfers a water content contained in a discharge gas, which is emitted from a fuel cell, to a supply gas, which is supplied to the fuel cell, when one of the discharge gas and the supply gas is passed through the inside of the tube type hollow thread members and the other one of the discharge gas and the supply gas is passed through between the tube type hollow thread members. Manometers detect a difference in pressure of the supply gas and the discharge gas, respectively, between an upper stream side and a down stream side of the humidifier. A determination unit determines a generation of clogging in the humidifier based on detection signals from the manometers. The products described in these patents disadvantageously suffer from clogging of the membranes, and require complex means for detecting and dealing with the clogging.

In U.S. Pat No. 6,939,629, Shimanuki et al., provide a humidifying system for a fuel cell that includes a fuel cell having an anode and a cathode, the anode being supplied with a fuel gas and the cathode being supplied with an oxidant gas so that the fuel gas and the oxidant gas chemically react within the fuel cell to generate electricity; a first humidifier transferring moisture of cathode exhaust gas discharged from the cathode of the fuel cell to the fuel gas through hollow fiber membranes; a second humidifier transferring moisture of cathode exhaust gas discharged from the first humidifier to the oxidant gas through hollow fiber membranes; and a reduced pressure generating device arranged downstream of the first humidifier and between the first humidifier and the fuel cell to mix part of anode exhaust gas discharged from the anode of the fuel cell with the fuel gas using negative pressure resulting from a flow of the fuel gas. The product described in this patent disadvantageously requires connecting apparati between the fuel cell and humidifier and other components, which add to system complexity and cost.

As is well known for proton-exchange-membrane fuel cells, purging the fuel path through the fuel cells is effective in returning the electrochemical reaction to full capacity. The purged fuel is typically vented from the fuel exhaust stream to the environment; however, due to the danger of creating a flammable mixture of fuel and air in the presence of a potential source of ignition, the purged fuel is diluted to below the lower flammability limit of the fuel before being exposed to a potential source of ignition, such as may be present in the environment. This dilution of purged fuel is typically effected by providing a fuel dilution system and method, such as a system that includes a fan, and a method that includes activation of the fan. Drawbacks of providing a fuel dilution system and method include the requirement of additional space, increased complexity for the fuel cell stack, and the potential danger of creating a flammable fuel and air mixture in the event that the fuel dilution system and method fails.

US patent application 2004/062975 to Yamamoto et al., provides an apparatus for dilution of discharged fuel of a fuel cell, which has an inlet for guiding purged hydrogen gas coming from the fuel cell, a reservoir for storing the purged hydrogen gas guided through the inlet, and a cathode exhaust gas pipe penetrating the reservoir. The cathode exhaust gas pipe has a feature that it has holes inside the reservoir and is supplied with cathode exhaust gas of the fuel cell. Also the apparatus has a feature that the cathode exhaust gas pipe sucks the purged hydrogen gas stored in the reservoir through the holes and discharges the purged hydrogen gas diluted by mixing with the cathode exhaust gas. The product described in this patent application disadvantageously requires the need for a dedicated system for the dilution of discharged fuel, the need for a dedicated reservoir for storing purged hydrogen, the need for additional piping dedicated for cathode exhaust and for purged hydrogen, and the need for additional piping dedicated to the combined cathode exhaust and purged hydrogen.

### SUMMARY OF THE INVENTION

A fluid management system for a fuel cell stack, the fluid management system comprising a) a humidifier comprising fuel and oxidant supply conduits each having a water permeable separator membrane, and fuel and oxidant exhaust conduits, wherein at least one of the exhaust conduits is in fluid communication with the separator membrane of at least one of the supply conduits and comprises a first liquid water separator that coalesces liquid water from an exhaust stream flowing through the exhaust conduit; and b) a manifold for fluidly coupling the humidifier and heat exchanger supply and exhaust conduits to corresponding supply and exhaust conduits of a fuel cell stack.

### BRIEF DESCRIPTION OF THE DRAWINGS

FIG. 1 is an isometric view of a fluid management system according to one embodiment of the invention connected to a fuel cell stack.

FIG. 2 is an isometric view of a fluid management system according to one embodiment of the invention.

FIG. 3 is an isometric view of a fluid management system according to one embodiment of the invention with an insulating jacket removed.

FIG. 4 is an isometric view of a fluid management system according to one embodiment of the invention with the insulating jacket and tension bands removed.

FIG. 5 is a side view of a fluid management system according to one embodiment of the invention.

FIG. 6 is a bottom view of a fluid management system according to one embodiment of the invention.

FIG. 7 is a cross-sectional view of humidifier assemblies of a fluid management system according to one embodiment of the invention.

FIG. 8 is an exploded isometric view of a fluid management system according to one embodiment of the invention.

FIG. 9 is an exploded isometric view of a fluid management system according to one embodiment of the invention showing a fuel flow path.

FIG. 10 is an exploded isometric view of a fluid management system according to one embodiment of the invention showing a fresh air flow path.

FIG. 11 is an exploded isometric view of a fluid management system according to one embodiment of the invention showing an exhaust humidified flow path.

FIG. 12 is an exploded isometric view of a fluid management system according to one embodiment of the invention showing a coolant flow path.

FIG. 13 is a side view of a fuel purge valve of a fluid management system according to one embodiment of the invention.

FIG. 14 is a flow chart showing a first method of operating the present invention.

FIG. 15 is a flow chart showing a second method of operating the present invention.

FIG. 16 is a schematic representation of the fluid management system according to one embodiment of the invention showing fluid flows.

FIG. 17 is a schematic representation of the fluid management system according to one embodiment of the invention showing fluid flows.

### DETAILED DESCRIPTION OF EMBODIMENTS OF THE INVENTION

In the following description, the coalescing of water refers to the uniting of liquid water droplets into larger liquid water drops. The condensing of water refers to the change of water vapor into liquid water. The terms pervaporation and permeation are used interchangeably.

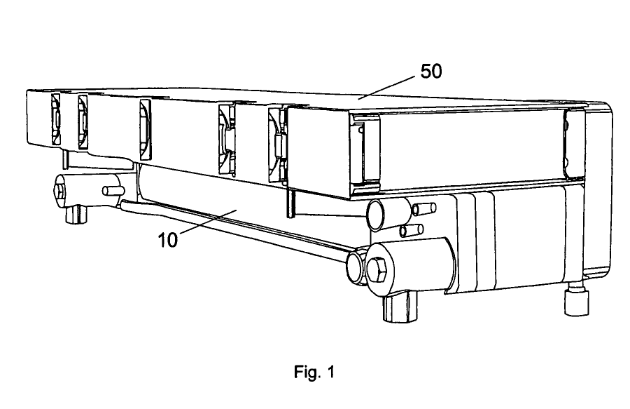

According to one embodiment of the invention and referring to FIG. 1, a fluid management system 10 is close coupled to a fuel cell stack 50, and serves to transfer heat and water vapor from reactant gas exhausts to reactant gas supplies; removes liquid water from the reactant gas exhausts; and transfers heat from the fuel cell stack 50 to gas supplies within the fluid management system 10 by way of a coolant circuit for the purpose of maintaining the gas supplies at their dewpoint temperature. In a preferred embodiment the fluid management system 10 is shaped to close couple to a Ballard Power Systems Model Mk902 fuel cell stack, which is depicted as fuel cell stack 50 formed as an elongate fuel cell stack with fluid inlets and outlets at opposing ends. In an alternate embodiment, the fluid management system 10 is shaped to close couple to a fuel cell stack of another design. Specifically in one alternate embodiment, a fuel cell stack may have all the fluid ports at one region of the fuel cell stack. In another embodiment of the present invention, the fluid management system is shaped to have a minimum size, and a fuel cell stack is shaped to close couple to the fluid management system.

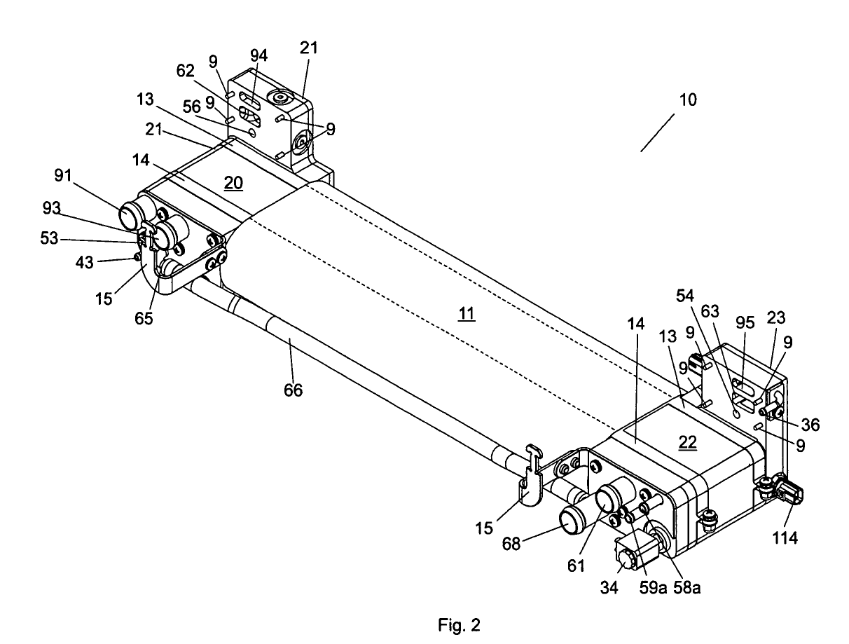

FIG. 2 shows the fluid management system 10 showing a first manifold 20, a first manifold cover 21, a second manifold 22, a second manifold cover 23, fuel cell stack fasteners 9, stack supports 15, and an insulating jacket 11. The insulating jacket 11 protects and insulates the components contained therein. In an alternate embodiment of the present invention, the insulating jacket covers the entire fluid management system. Close coupling of the fluid management system 10 to a fuel cell stack 50 is achieved by conforming the shape of the fluid management system 10 to the fuel cell stack 50, and directly coupling the manifolds 20, 22 to the manifolds of the fuel cell stack 50, thereby avoiding the need for connecting apparati such as pipes and tubes.

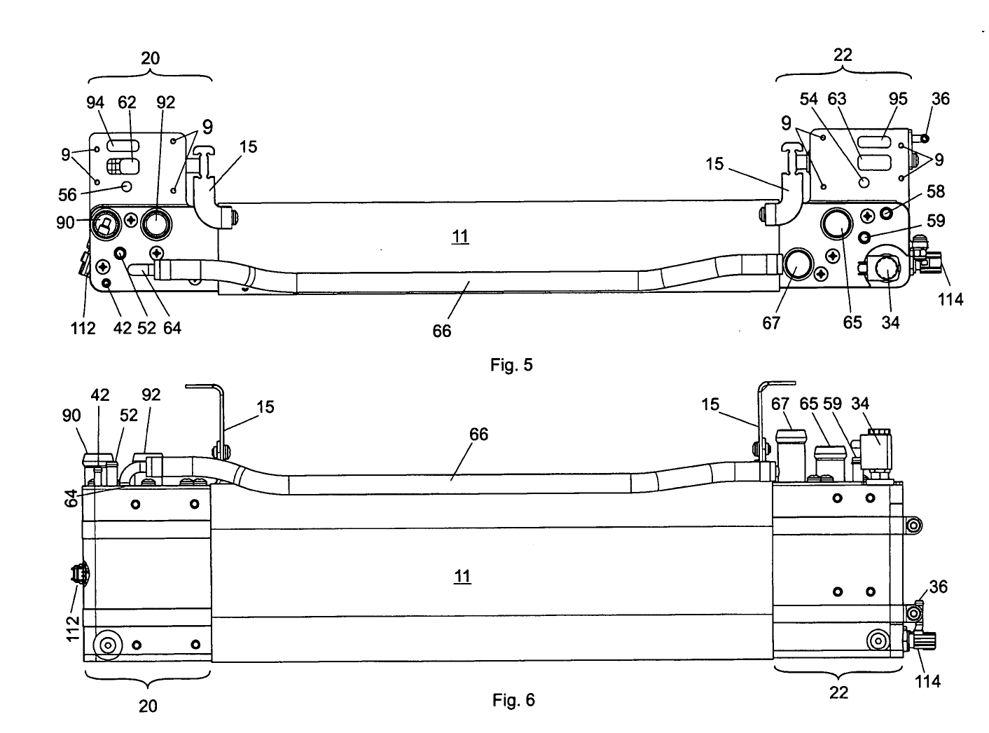

FIG. 5 is a side view and FIG. 6 is a bottom view of the embodiment of the invention shown in FIG. 2.

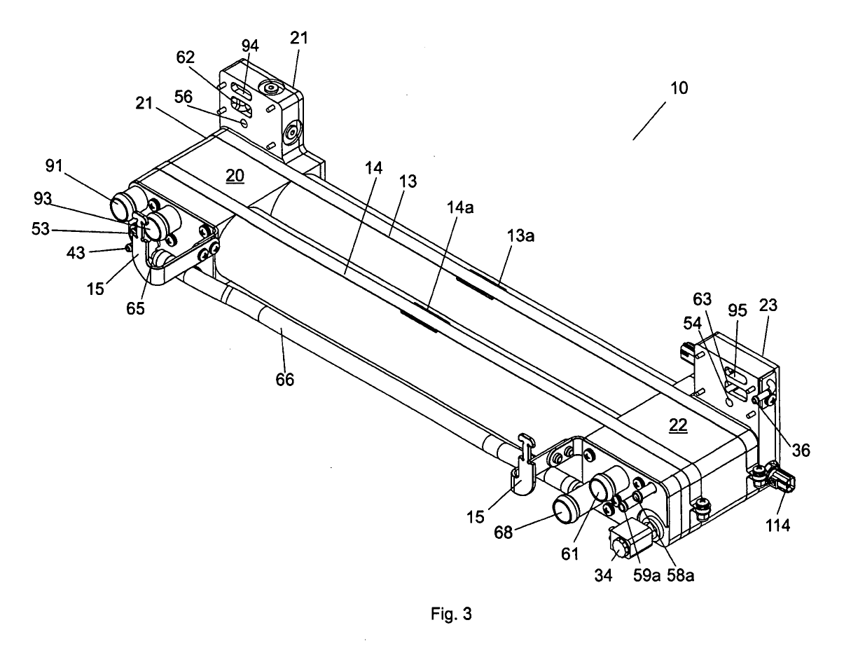

FIG. 3 shows the fluid management system 10 without the insulating jacket 11, showing a first tension band 13 and a second tension band 14. The first tension band 13 fastens a fuel humidification assembly 17 to the first and second manifolds 20, 22. The second tension band 14 fastens an oxidant humidification assembly 18 to the first and second manifolds 20, 22. The first tension band 13 is held away from the fuel humidification assembly 17 by a first tension band pad 13a. The second tension band 14 is held away from the oxidant humidification assembly 18 by a second tension band pad 14a.

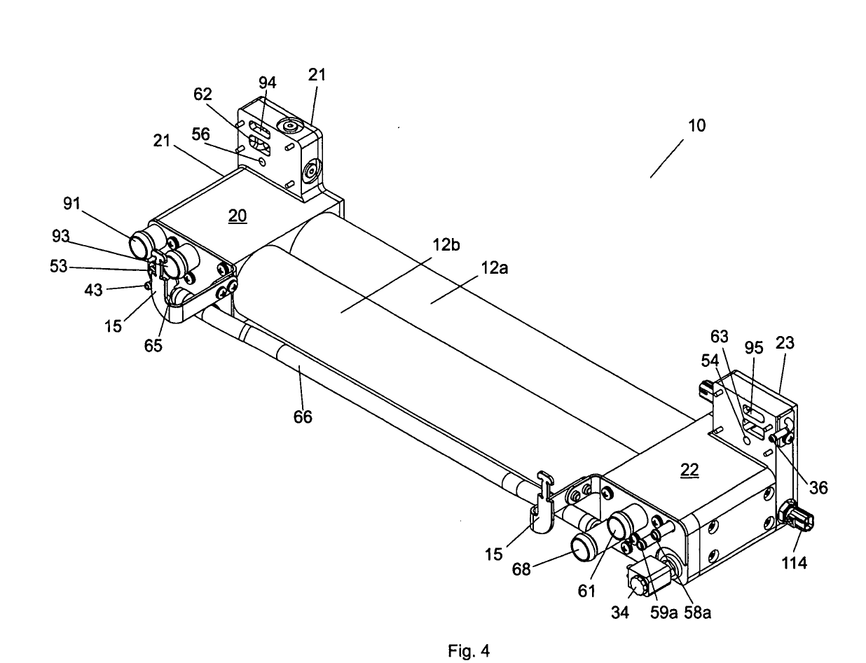

FIG. 4 shows the fluid management system 10 without the insulating jacket and without tension bands and without first and second tension bad pads, and showing a first temperature control jacket 12a of the fuel humidification assembly 17 and a second temperature control jacket 12b of the oxidant humidification assembly 18.

In the preferred embodiment of the invention, the fluid management system 10 comprises two manifolds 20, 22 coupled to two humidification assemblies 17, 18. In an alternate embodiment of the present invention, one manifold performs the functions of the two described manifolds of the preferred embodiment by arranging all the fluid flow paths to traverse one manifold. In a further alternate embodiment of the present invention, one humidification assembly performs the functions of the two described humidification assemblies of the preferred embodiment by arranging one humidification assembly inside the other humidification assembly.

In the preferred embodiment of the invention, each humidification assembly 17,18 is largely tubular in shape, and various chambers and passages are formed largely as a series of concentric largely tubular chambers, one inside the other, while some passages are orifices that allows fluids to pass from one largely tubular chamber to an adjacent largely tubular chamber. In an alternate embodiment of the present invention, each humidification assembly is largely rectangular in shape, and various compartments and passages are formed partly as a series of plates, one plate beside the adjoining plate, one plate surface coupled to the adjoining plate surface.

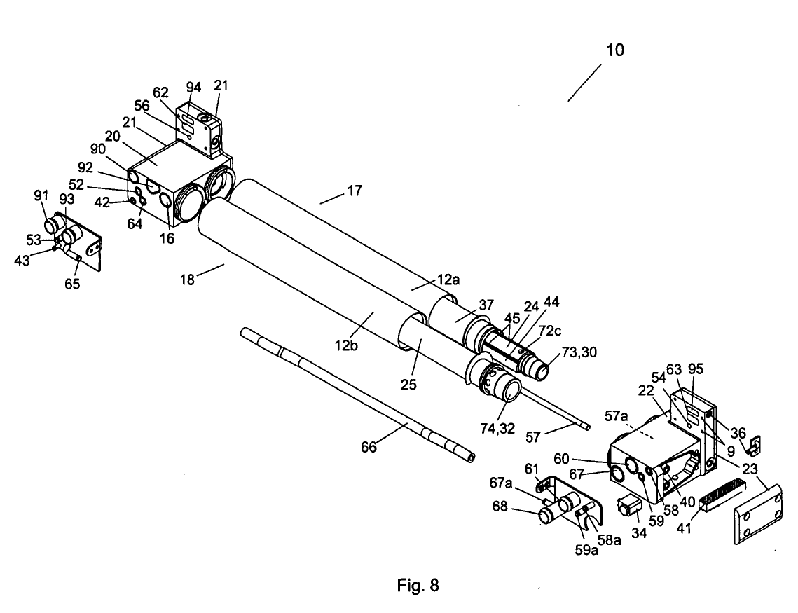

FIG. 8 shows an exploded isometric view according to one embodiment of the fluid management system 10 without the insulating jacket 11, and without the tension bands 13, 14, and without first and second tension bad pads 13a, 14a. A first access gallery 16 is provided for assembly and maintenance to the first manifold 20. A second access gallery (not shown) is provided for assembly and maintenance to the second manifold 22.

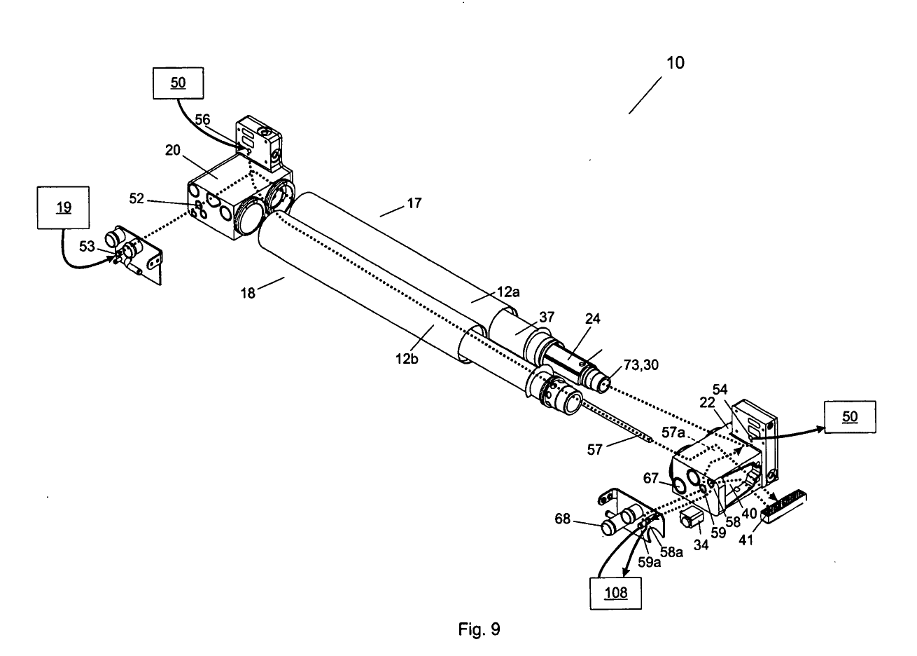

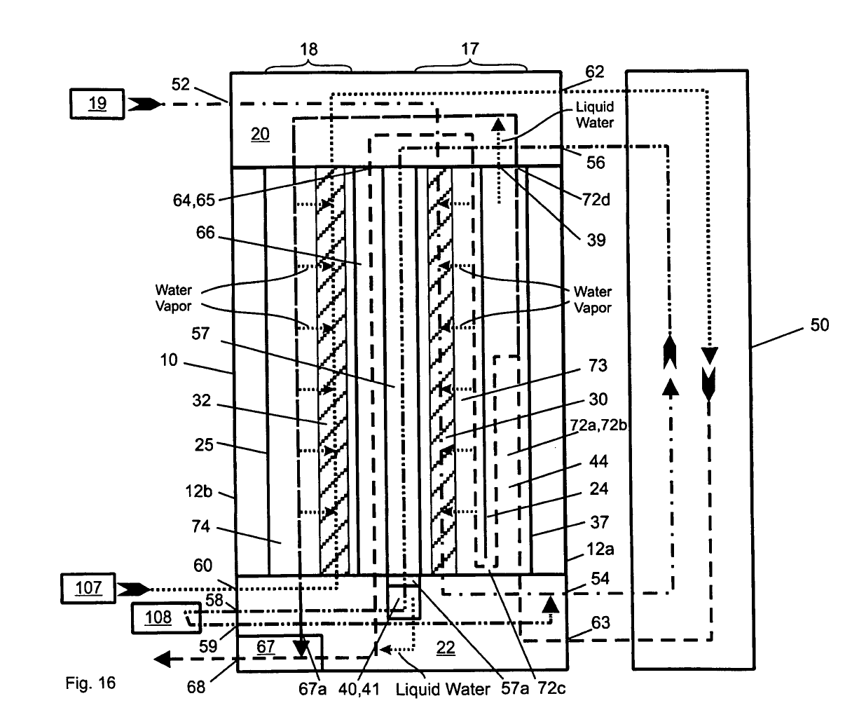

FIGS. 9 and 16 show the path that a fuel supply stream takes traversing the fluid management system 10 in the preferred embodiment of the invention. The fuel supply for fuel cell stack 50 comes from a fuel source 19. The fuel supply stream enters the fluid management system 10 through a fuel supply inlet port 53 and a fuel supply inlet 52 into the first manifold 20. The fuel source 19 contains a pressurized gaseous fuel. The pressure of the gaseous fuel provides sufficient force to transfer the fuel supply stream through the fluid management system 10 to the fuel cell stack 50 and back to the fluid management system 10 whenever a path to the fluid management system is opened.

Fuel sources 19 are well understood with respect to fuel cells, and may comprise a plurality of components, including a pressure vessel, a pressure vessel shutoff valve assembly, a motor operated supply valve, a check valve, a pressure relief valve, pipes, tubes and couplings (none shown). The pressure vessel holds a pressurized gaseous fuel, when operational. The path from the fuel source 19 to a fluid management system and a fuel cell stack is opened and the fuel starts to flow when a supply valve (not shown) is opened. The supply valve opens and closes in response to signals from a fuel cell system controller (not shown), and may be partially open.

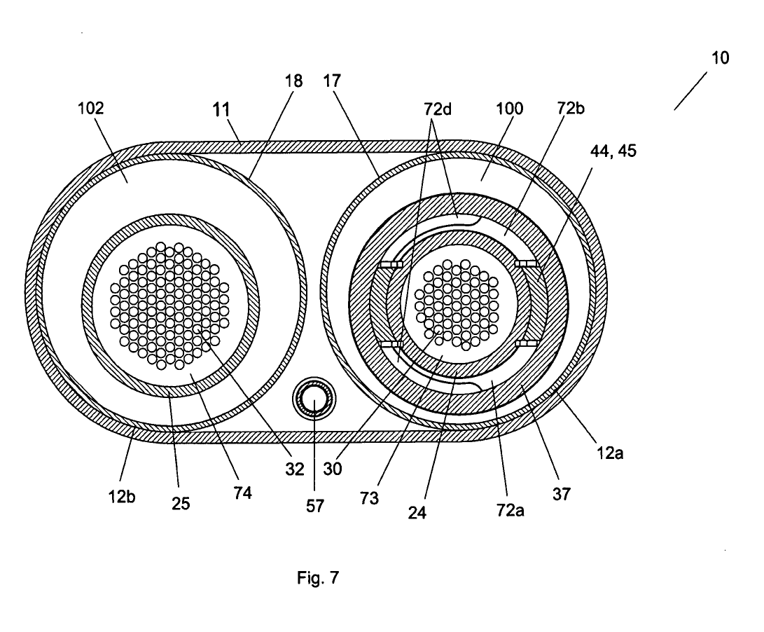

With reference to FIG. 7, the fuel supply stream passes from the first manifold 20 into the inside of a first membrane tube bundle 30 arranged longitudinally within a fuel humidification chamber 73 inside a fuel humidification shell 24 of the fuel humidification assembly 17. The fuel supply stream is humidified within the first membrane tube bundle 30 by the pervaporation of water vapor from an oxidant exhaust stream within the fuel humidification chamber 73 into the membrane tubes of the first membrane tube bundle 30. The path of the oxidant exhaust stream through the fluid management system will be described.

The humidified fuel supply stream leaves the fuel humidification assembly 17 and enters the second manifold 22. From the second manifold 22, the humidified fuel supply stream transfers to a humidified fuel supply port 54 where it leaves the fluid management system 10 and enters the fuel cell stack 50 for consumption in the electrochemical reaction to generate electricity.

Some of the fuel supply stream is consumed in the fuel cell stack 50 to generate electricity. The unconsumed fuel (“fuel exhaust”) stream from the fuel cell stack 50 enters the fluid management system 10 through a fuel exhaust port 56 into the first manifold 20. From the first manifold 20, the fuel exhaust stream passes through a fuel transfer line 57 to a fuel exhaust passage 57a within the second manifold 22. Within the fuel exhaust passage, the fuel exhaust stream passes through a first water coalescing separator 40, which contains a first water coalescing medium 41, that coalesces liquid water from the fuel exhaust stream and allows the liquid water to fall under gravity to the bottom of the fuel exhaust passage 57a where the liquid water accumulates.

In the preferred embodiment of the invention, the fuel water coalescing medium 41 is a polyester mesh distributed by the company Merryweather Foam under the brand and number Regicell 10, however, other similar meshes may be used instead without detracting from the invention.

The fuel exhaust stream leaves the coalescing separator 40 and leaves the fluid management system 10 by way of a fuel recirculation outlet 58 and a fuel recirculation outlet port 58a to a fuel recirculation pump 108. From the fuel recirculation pump 108, the fuel exhaust stream re-enters the fluid management system 10 through a fuel recirculation inlet port 59a and a fuel recirculation inlet 59 into the second manifold 22 and blends with the humidified fuel stream upstream of the humidified fuel supply port 54. Blending of the two fuel streams is accomplished by the simple joining of the passages that carry the humidified fuel supply stream and the fuel exhaust stream. The blending rate is controlled by design through the relative sizing of the respective two input passages and the one output passage. The fuel recirculation pump 108 adds sufficient force to the fuel exhaust stream to transfer the fuel stream through the fluid management system 10 to the fuel cell stack 50 and back to the fluid management system 10.

Fuel recirculation pumps 108 are well understood with respect to fuel cells, and may comprise a plurality of components, including a circulation pump, a pump motor, a flow sensor, a pressure sensor, a fuel filter, pipes, tubes, couplings and a power source for those components that require power to operate (none shown). In an alternate embodiment of the present invention, the fuel recirculation pump 108 is integrated with the fluid management system 10 within a single housing.

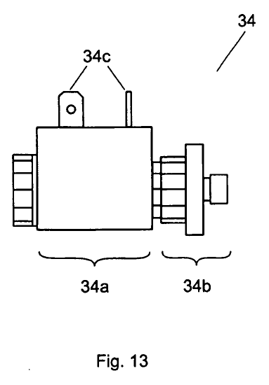

In the preferred embodiment of the invention, a fuel purge valve 34 is provided on the fluid management system 10 to actively effect the venting of fuel purged from the fuel cell stack 50 and to simultaneously passively effect the draining of accumulated liquid water from the bottom of the fuel exhaust passage 57a. The purged fuel and accumulated liquid water is directed to the second oxidant exhaust stream within the second manifold 22 by the opening of the fuel purge valve 34. With reference to FIG. 13, the fuel purge valve 34 consists of an actuation portion 34a and a flow directing portion 34b. At least the flow directing portion 34b is located within the fuel exhaust passage 57a of the second manifold 22 and, when open, creates a passage from the fuel exhaust stream to the second oxidant exhaust stream just upstream of a first oxidant exhaust outlet 67. The purged fuel and accumulated liquid water combines with the second oxidant exhaust stream and flow through the first oxidant exhaust outlet 67 and a first oxidant exhaust outlet port 68 to the environment.

The fuel purge valve 34 is opened and closed by way of signals from a fuel cell system controller (not shown) that are transmitted to the fuel purge valve by way of fuel purge valve electrical signal connectors 34c. A fuel cell system controller may automatically open and close the purge valve 34 at a regular time interval or in response to voltage signals from the fuel cell stack 50, or as a combination of time interval and voltage signals.

In the preferred embodiment of the invention, the fuel purge valve 34 is a shutoff valve distributed by the company Components For Automation under the part number 538, and adapted to fit the preferred embodiment of the invention, but may be another shutoff valve without detracting from the invention.

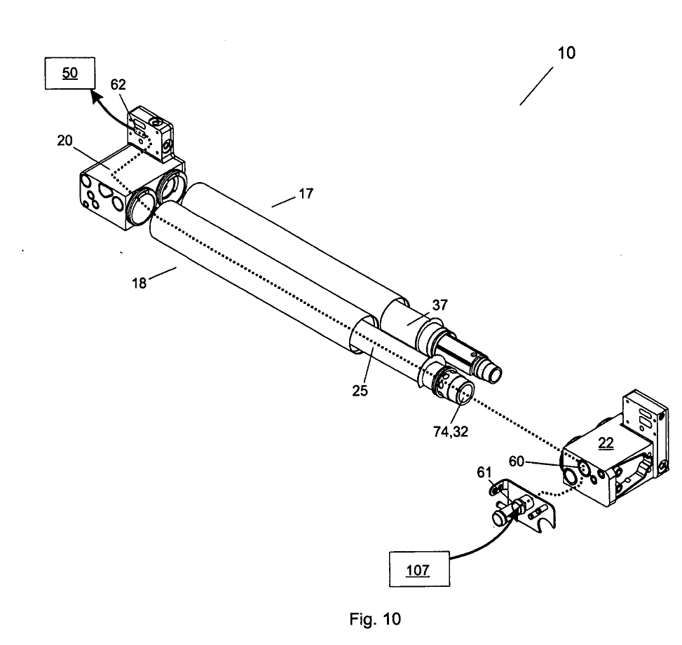

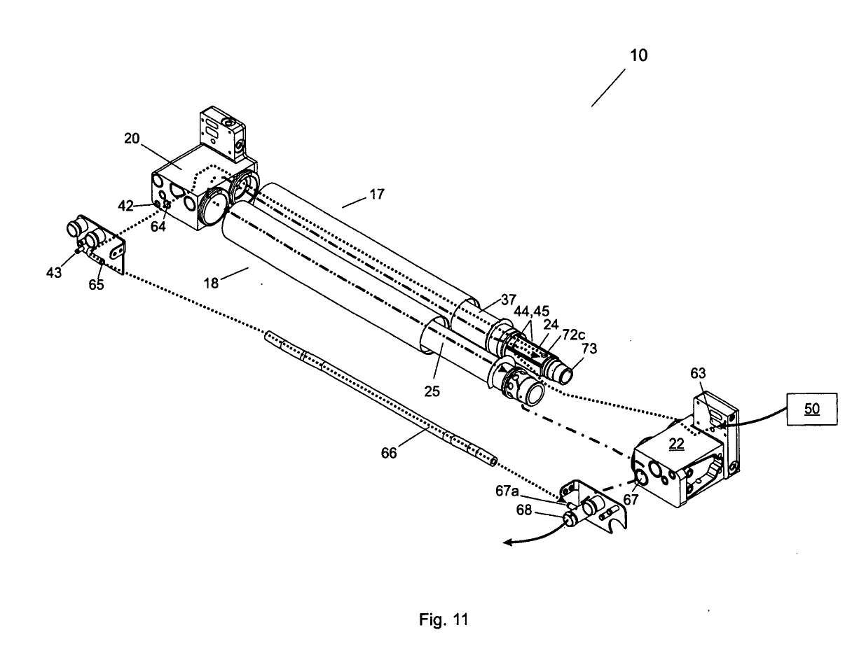

FIGS. 10 and 16 show the path that an oxidant supply stream takes traversing the fluid management system 10 in the preferred embodiment of the invention. The oxidant supply stream traverses an oxidant supply circuit 107, and enters the fluid management system 10 through an oxidant supply inlet port 61 and an oxidant supply inlet 60 into the second manifold 22. With reference to FIG. 7, from the second manifold 22 the oxidant supply stream passes into the inside of the membrane tubes of a second membrane tube bundle 32 arranged longitudinally within an oxidant humidification chamber 74 inside an oxidant humidification shell 25 of the oxidant humidification assembly 18.

The oxidant supply stream is humidified within the second membrane tube bundle 32 by the pervaporation of water vapor from the oxidant exhaust stream within the oxidant humidification chamber 74 into the second membrane tube bundle 32. The humidified oxidant supply stream leaves the second humidification assembly 18 and enters the first manifold 20. From the first manifold 20, the humidified oxidant supply stream transfers to a humidified supply oxidant port 62 where it leaves the fluid management system 10 and enters the fuel cell stack 50 for consumption in the electrochemical reaction to generate electricity.

Oxidant supply circuits 107 are well understood with respect to fuel cell power systems, and may comprise a plurality of components, including a compressor, a shutoff valve assembly, a filter, a motor operated supply valve, a check valve, a pressure relief valve, pipes, tubes and couplings (none shown). The path from the oxidant supply circuit 107 to the fluid management system and the fuel cell stack is opened and the oxidant starts to flow when a supply valve (not shown) is opened. The supply valve opens and closes in response to signals from a fuel cell system controller (not shown), and may be partially open.

In the preferred embodiment of the invention, the force necessary to transfer the oxidant supply stream through the fluid management system 10 to the fuel cell stack 50 is provided by an oxidant supply circuit 107 that is external to the fluid management system. In an alternate embodiment of the present invention, an oxidant supply circuit is integrated with the fluid management system 10 within a single housing.

Some of the oxidant supply is consumed in the fuel cell stack 50 to generate electricity. FIGS. 11 and 16 show the path that the unconsumed oxidant (“oxidant exhaust”) stream takes traversing the fluid management system 10. The oxidant exhaust stream from the fuel cell stack 50 enters the fluid management system 10 through an oxidant exhaust inlet 63 into the second manifold 22. With reference to FIG. 7, from the second manifold 22 the oxidant exhaust passes into the fuel humidification assembly 17 where it enters an oxidant coalescing separator inlet passage 72a inside of a separator shell 37. From the oxidant coalescing separator inlet passage 72a, the oxidant exhaust passes upward through at least one oxidant water coalescing separator 44 into an oxidant coalescing separator outlet passage 72b. The oxidant water coalescing separator 44 comprises a mostly vertically elongate chamber that allows liquid water from the oxidant exhaust stream to coalesce and fall under gravity to the bottom of the oxidant coalescing separator inlet passage 72a.

The oxidant water coalescing separator 44 may optionally contain a water coalescing medium 45. In the preferred embodiment of the invention, the optional oxidant water coalescing medium is a polyester mesh distributed by the company Merryweather Foam under the brand and number Regicell 10, however, other similar meshes may be used instead without detracting from the invention.

From the oxidant coalescing separator outlet passage 72b, the oxidant exhaust splits into a first and a second oxidant exhaust stream. The first oxidant exhaust stream enters a fuel humidification chamber oxidant inlet 72c, which is comprised of an orifice through a fuel humidification shell 24, and from there enters the fuel humidification chamber 73. The fuel humidification chamber oxidant inlet 72c is sized to allow a predetermined portion of the total oxidant exhaust stream into the fuel humidification chamber 73.

Within the fuel humidification chamber 73 the first oxidant exhaust stream flowingly surrounds the first membrane tube bundle 30. Some of the water vapor entrained in the oxidant exhaust stream pervaporates into the first membrane tube bundle 30 to humidify the fuel supply stream within.

The second oxidant exhaust stream enters an oxidant passage outlet 72d, and from there passes through the first manifold 20 to the oxidant humidification chamber 74 within the oxidant humidification assembly 18, where the second oxidant exhaust stream flowingly surrounds the second membrane tube bundle 32. Some of the water vapor entrained in the second oxidant exhaust stream pervaporates into the second membrane tube bundle 32 to humidify the oxidant supply stream within.

The first and second membrane tube bundles 30, 32 are bundles of tubes made of the membrane sold under the brand NAFION, a polymer manufactured by the company DuPont, or some similar ion-conductive polymer such as a perfluorocarbonsulfonic acid-based ionomer. In the preferred embodiment of the invention, the membrane tube bundles are provided in assemblies manufactured by the company Permapure and distributed under the part numbers DB-125 and DB-150; however, other similar bundles of hollow thread water permeable membranes may be used instead without detracting from the invention. In an alternate embodiment of the present invention, the membrane tube bundles 20, 22 are replaced by a single membrane tube.

In an alternate embodiment of the present invention, a single oxidant exhaust stream passes sequentially through the both of the fuel humidification assembly 17 and the oxidant humidification assembly 18.

In the preferred embodiment of the invention, the second oxidant exhaust stream passes from the oxidant humidification chamber 74 into the second manifold 22 from where it passes through the first oxidant exhaust outlet 67 and the first oxidant exhaust outlet port 68 to the environment.

The first oxidant exhaust stream passes from the fuel humidification chamber 73 into the first manifold 20, from where it passes through a second oxidant exhaust outlet 64 and a second oxidant exhaust outlet port 65 into an oxidant exhaust transfer line 66. The second oxidant exhaust stream traverses the oxidant exhaust transfer line 66 to a third oxidant exhaust outlet 67a, where it joins the second oxidant exhaust stream upstream of the first oxidant exhaust outlet port 68, from where it passes through the first oxidant exhaust outlet port 68 to the environment.

In the preferred embodiment of the invention, the accumulated liquid water at the bottom of the oxidant coalescing separator inlet passage 72a is carried partly under the force of gravity and partly from the pressure of the second oxidant exhaust stream to the oxidant passage outlet 72d (shown on FIG. 7) on the first manifold 20 and continues with the second oxidant exhaust stream on its path to the environment.

In an alternate embodiment of the present invention, the accumulated liquid water is directed from the first manifold 20 to a water drain 42 and a water drain port 43 to the environment.

The source of water for the fluid management system 10 is the water produced by the electrochemical reaction between hydrogen and oxygen within a fuel cell, commonly referred to as product water. Product water accumulates primarily on the oxidant side of a PEM fuel cell, and is removed from the fuel cell by the flow of the oxidant exhaust. Product water takes the form of partly liquid water and partly water vapor. In the preferred embodiment of the invention, the liquid water is coalesced, separated and removed within the fluid management system 10 and the water vapor is retained in the fuel exhaust and in the oxidant exhaust, and the water exhaust in the oxidant exhaust is at least in part, transferred to the gas supplies. As the oxidant exhaust contains water vapor from the product water, the water vapor is available for the humidification of the fuel supply and the oxidant supply.

During operation of a fuel cell stack 50, the water vapor entrained in the gas supplies is not consumed. Fuel is partly consumed during operation of the fuel cell; therefore the water vapor entrained in the fuel supply stream is concentrated in the fuel exhaust stream, leading to condensation of some of the water vapor to liquid water. The fuel exhaust stream is therefore saturated and contains liquid water, and can be recirculated to the fuel cell stack 50 without additional humidification. The liquid water in the fuel exhaust stream is advantageously removed in the preferred embodiment of the present invention in order to protect the fuel circulation pump 108 from damage.

The oxygen in the oxidant supply stream is partly consumed during operation of the fuel cell stack 50; therefore the water vapor entrained in the oxidant supply stream is concentrated in the oxidant exhaust stream, leading to condensation of some of the water vapor to liquid water. Additionally, the consumed fuel and oxidant combine on the oxidant side of the PEM fuel cell membranes to produce product water, as noted above. The oxidant exhaust stream is therefore saturated and contains liquid water. The water vapor in the oxidant exhaust stream is advantageously transferred to the fuel supply stream and to the oxidant supply stream by pervaporation through the first and second membrane tube bundles 30, 32 respectively. The liquid water in the oxidant exhaust stream is advantageously removed in the preferred embodiment of the present invention in order to prevent clogging of the membrane tube bundles 30, 32.

An objective of the fluid management system is humidification of fuel cell supply gases to as close to saturation as possible without allowing the condensation of water vapor to liquid water. As the saturation level of water vapor in a gas is relative to the gas temperature, near saturation is accomplished by setting a target temperature for the gas supply that is slightly below, for example 2°C. below, the dewpoint temperature of the gas supply. As the dewpoint of the gas supply varies with the temperature of the gas supply, the selection of the gas dewpoint as the controlling parameter ensures that near saturation is achieved at all fuel cell operating temperatures.

The fuel cell operating temperature is measured in the preferred embodiment of the invention by sensing the fuel cell coolant temperature at the fuel cell stack coolant inlet, and the measurement is communicated to a fuel cell system controller, which in turn controls changes to one or both of the coolant flow rate and coolant temperature accordingly within a coolant heat rejection circuit 109.

Fuel cells are well known to generate heat while operating. Fuel cell stacks are well known to incorporate a coolant system for the heat management of the fuel cell stack. Heat is commonly rejected from the coolant stream in a coolant heat rejection circuit as required by the fuel cell stack under the control of a fuel cell system controller.

In the preferred embodiment of the invention, a purpose of circulating a coolant from the fuel cell stack 50 to the fluid management system 10 is to maintain the fuel cell stack 50 and the fluid management system 10 at as near the same temperature as practicable. A purpose of close coupling the fuel cell stack 50 to the fluid management system 10 is to maintain the fuel cell stack 50 and the fluid management system 10 at as near the same temperature as possible. By maintaining the fuel cell stack 50 and the fluid management system 10 at as near the same temperature as practicable, the condensation of water in the gas supplies and gas exhausts within the fluid management system 10 is largely prevented, and the dewpoint temperature of the gas supplies is maintained at as high a temperature as practicable. By maintaining the dewpoint temperature as high as practicable, water vapor content of the supply gases can be maintained as close to saturation as practicable. By maintaining the water vapor content of the supply gases as close to saturation as practicable, the effectiveness of the fuel cell stack's power generation capability is enhanced.

The temperature of a fuel cell stack 50 is close to ambient when the fuel cell stack 50 is not operating. In the preferred embodiment of the invention, upon start-up of the fuel cell stack 50 and the fluid management system 10, the temperature of the fuel cell stack 50 rises in response to the heat regenerated in the electrochemical reaction of the fuel cell stack 50. During start-up of the fuel cell stack 50, and the fluid management system 10, the fuel cell gas supplies are humidified in the fluid management system 10 to near saturation very quickly, as the amount of input water vapor that is required for near saturation humidification of the supply gases is small, and is adequately supplied by the fuel cell stack's product water and carried to the fluid management system 10 by the oxidant exhaust stream. During the warm-up period between start-up and full-temperature operation of the fuel cell stack 50 and the fluid management system 10, in which the fuel cell operating temperature rises from near ambient temperature to full operating temperature, the near saturation of the supply gases is maintained by the simultaneous increase in the amount of source water vapor from the fuel cell stack's product water produced by the fuel cell stack 50 and carried by the oxidant exhaust stream to the fluid management system 10.

In the preferred embodiment of the invention, the temperature of the supply gases is maintained at near the temperature of the fuel cell stack 50 by the close coupling of the fluid management system 10 to the fuel cell stack 50, and by control of the flow rate and temperature of the coolant stream that passes between the fuel cell stack 50 and the fluid management system 10.

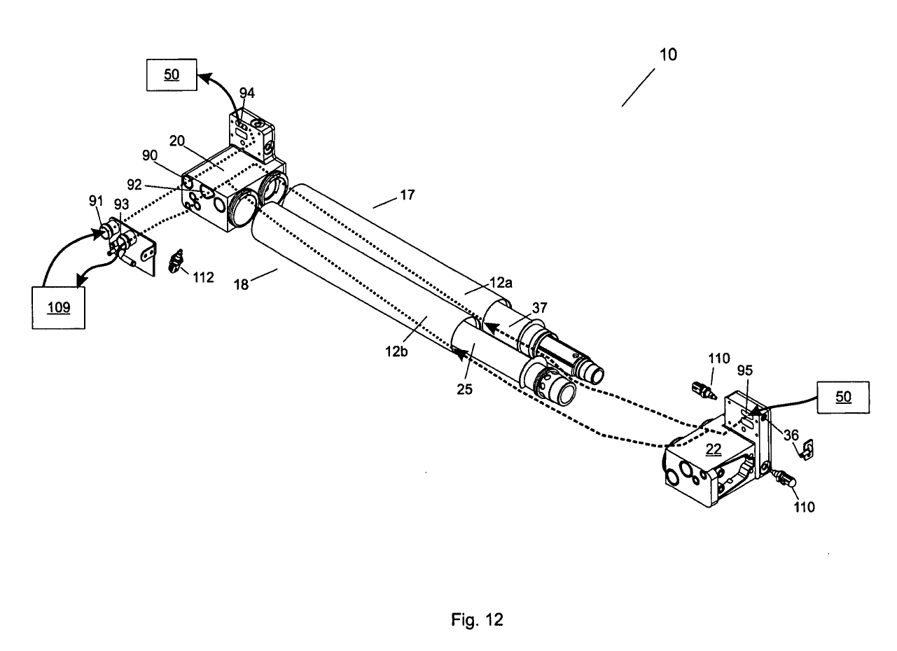

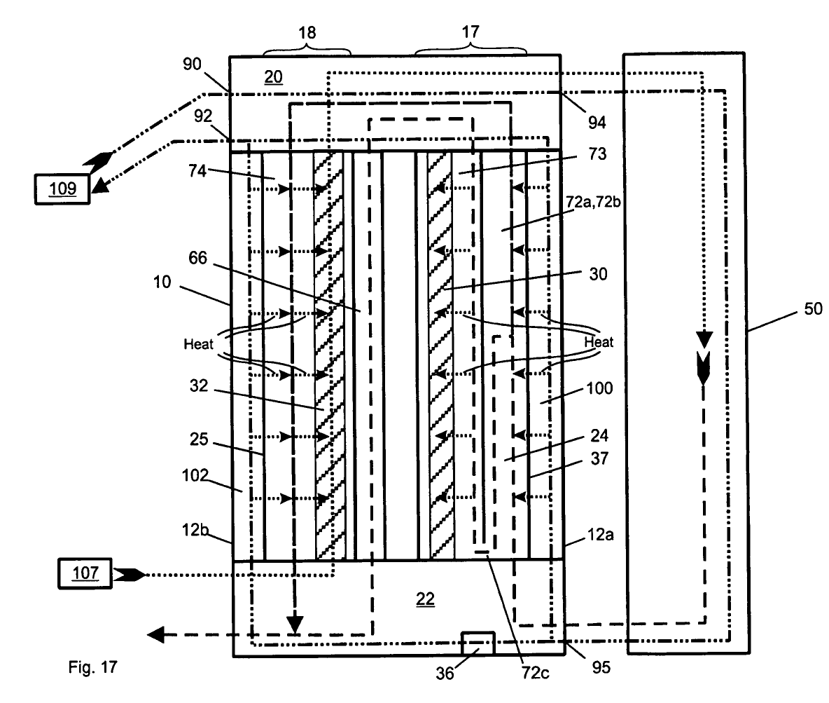

FIGS. 12 and 17 show the path that a coolant stream takes traversing the fluid management system 10 and the fuel cell stack 50 in the preferred embodiment of the invention. From a coolant heat rejection circuit 109, the coolant stream enters the fluid management system 10 through a coolant inlet port 91 and a coolant inlet 90 into the first manifold 20, from where it leaves the fluid management system 10 through a coolant supply port 94 to the fuel cell stack 50, where it absorbs heat from the fuel cell stack 50 during fuel cell operation.

In an alternate embodiment of the present invention, the coolant stream passes from the coolant heat rejection circuit 109 to the fuel cell stack 50 without passing through the fluid management system 10.

In the preferred embodiment of the invention, the coolant stream from the fuel cell stack 50 enters the fluid management system 10 through a coolant return port 95 into the second manifold 22 where it splits into a first and a second coolant stream. The first coolant stream passes from the second manifold 22 into a first coolant passage 100 (shown in FIGS. 7 and 17) inside of the first temperature control jacket 12a of the fuel humidification assembly 17. The coolant transfers heat conductively through the separator shell 37 to the oxidant exhaust stream therein. The path of the first and second oxidant exhaust streams from within the separator shell 37 to within the fuel humidification chamber 73 and to within the oxidant humidification chamber 74 was described. The first oxidant exhaust stream carries the entrained heat to within the fuel humidification chamber 73 and transfers heat conductively and convectively through the first membrane tube bundle 30 to the supply fuel within. The second oxidant exhaust stream carries the entrained heat to within the oxidant humidification chamber 74 and transfers heat conductively and convectively through the second membrane tube bundle 32 to the supply oxidant within.

The second coolant stream passes from the second manifold 22 into a second coolant passage 102 (shown in FIGS. 7 and 17) inside of the second temperature control jacket 12b of the oxidant humidification assembly 18. The coolant transfers heat conductively through the oxidant humidification shell 25 to the second oxidant exhaust stream within the oxidant humidification chamber 74. A function of the second coolant stream is to ensure that the temperature of the second oxidant exhaust stream is maintained at as near the same temperature as the first oxidant exhaust stream as practicable.

The first coolant stream and the second coolant stream join within the first manifold 20, and the combined coolant stream leaves the fluid management system 10 through a coolant outlet 92 and a coolant outlet port 93 to the coolant heat rejection circuit 109.

In an alternate embodiment of the present invention, the fluid management system 10 includes only a first coolant stream.

In an alternate embodiment of the present invention, the coolant passes through only one of the fuel humidification assembly 17 and the air humidification assembly 18.

Coolant heat rejection circuits are well understood with respect to fuel cell power systems, and may comprise a plurality of components, including a coolant reservoir, reservoir level switches, temperature sensor, flow sensor, radiator, radiator fan, valves, pipes, tubes, couplings and power sources for those components that require power to operate (none shown). The flow of coolant through the coolant heat rejection circuit is controlled in response to signals from a fuel cell system controller, and may be partially open. The temperature of coolant through the coolant heat rejection circuit is controlled in response to signals from a fuel cell system controller. In the preferred embodiment of the invention, the coolant is water, but in an alternate embodiment of the present invention the coolant is a glycol solution. In an alternate embodiment of the present invention, the coolant heat rejection circuit 109 is integrated with the fluid management system 10 within a single housing.

In the preferred embodiment of the invention, coolant can be bled from the fluid management system 10 by way of a coolant bleed port 36, when coolant removal is required for maintenance of the fluid management system 10 or of the fuel cell stack 50.

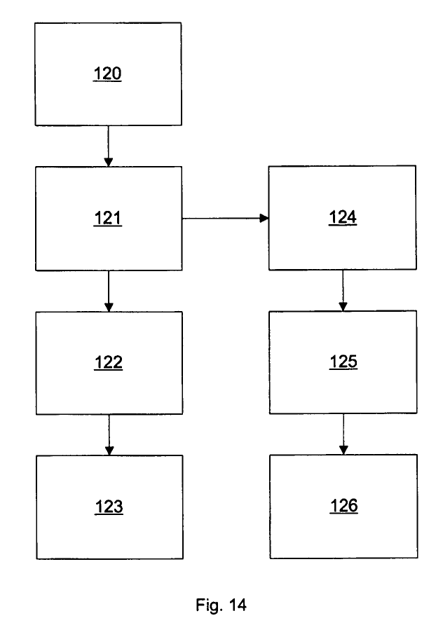

With reference to FIGS. 12 and 14, a coolant inlet temperature transducer 112 in the first manifold 20 and a coolant outlet temperature transducer 110 in the second manifold 22 measure the temperature of the coolant at their respective locations in Step 120 of FIG. 14. The temperature data from transducers 112, 110 is transferred electronically to a fuel cell system controller (not shown) in Step 121. In Step 122, the fuel cell system controller compares the measured temperatures against a predetermined range of operational temperatures, and when a measured temperature is different from the predetermined range of said operational temperatures, the fuel cell system controller in Step 123 signals the coolant circulation circuit to increase or decrease the coolant temperature accordingly. The coolant circulation circuit may increase or decrease the coolant temperature through a variety of methods well known in the art, such as direct a portion of the coolant stream through a radiator included in the coolant circulation circuit 109.

Additionally, in Step 124 the fuel cell system controller subtracts the temperature reading from the coolant inlet temperature transducer 112 from the temperature reading of the coolant outlet temperature transducer 110 to determine the temperature differential of the coolant between the locations of the two transducers 112, 110. In Step 125, the fuel cell system controller compares the temperature differential determined in Step 124 against a predetermined range of operational temperature differentials. When the measured temperature differential is different from the predetermined range of said operational temperature differentials, the fuel cell system controller signals the coolant circulation circuit to increase or decrease the flow of the coolant stream in Step 126. The coolant circulation circuit may increase or decrease the flow of the coolant stream through a variety of methods, well known in the art, such as increase or decrease the speed of a pump included in the coolant heat rejection circuit 109.

In the preferred embodiment of the invention, the coolant outlet temperature transducer 110 and the coolant inlet temperature transducer 112 are temperature transducers distributed by the Ford Motor Company under the part number F6AZ-9F951-AA, but may be other temperature transducers without detracting from the invention.

In the preferred embodiment of the invention, an oxidant temperature transducer 114 in the second manifold 22 measures the temperature of the oxidant exhaust. The temperature data from the oxidant temperature transducer 114 is transferred electronically to a fuel cell system controller (not shown). The fuel cell system controller uses the oxidant exhaust temperature data to create high-temperature warnings and alarms for the fuel cell stack 50. In the preferred embodiment of the invention, the oxidant temperature transducer 114 is a temperature transducer distributed by the Ford Motor Company under the part number F6AZ-9F951-AA, but may be another temperature transducer without detracting from the invention.

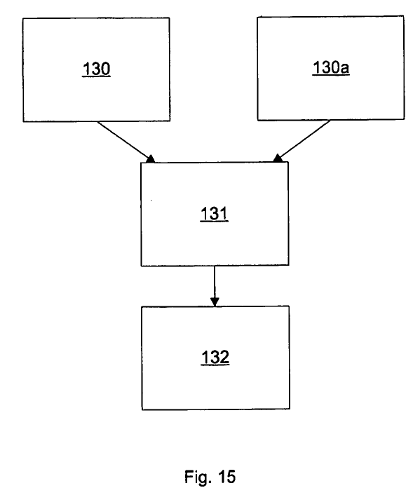

With reference to FIG. 15, a fuel cell system controller (not shown) receives a signal from a fuel cell transducer in Step 130, or from a timer that times fuel cell operation in Step 130a. The fuel cell system controller compares the signals against a predetermined set of operational parameters and fuel cell operation times in Step 131. When the received signal is different from the predetermined range of said operational parameters, or the time has exceeded a fuel cell operation time, the fuel cell system controller signals the fuel purge valve 34 to open for a predetermined length of time in Step 132.

In the preferred embodiment of the invention, the fuel is gaseous hydrogen. In alternate embodiments of the present invention, the fuel may be another gaseous fuel such as methane, propane, butane, vaporized methanol, vaporized ethanol, vaporized gasoline, vaporized hydrogen peroxide, or another gaseous fuel, or any combination thereof. Furthermore, the gaseous fuel may be reformate, which is mostly hydrogen mixed with other fuels, and is created when a hydrocarbon fuel such as natural gas is reformed.

In the preferred embodiment of the invention, the oxidant is air. In alternate embodiments of the present invention, the oxidant is oxygen, or a gas containing a significant portion of oxygen, for example, 20% oxygen.

It is to be understood that even though various embodiments and advantages of the present invention have been set forth in the foregoing description, the above disclosure is illustrative only, and changes may be made in detail, and yet remain within the broad principles of the invention. Therefore, the present invention is to be limited only by the claims appended to the patent.

1. A fluid management system for a fuel cell stack, the fluid management system comprising
(a) a humidifier comprising fuel and oxidant supply conduits each having a water permeable separator membrane, and fuel and oxidant exhaust conduits, wherein at least one of the exhaust conduits is in fluid communication with the separator membrane of at least one of the supply conduits and comprises a first liquid water separator that coalesces liquid water from an exhaust stream flowing through the exhaust conduit; and
(b) a manifold for fluidly coupling the humidifier and heat exchanger supply and exhaust conduits to corresponding supply and exhaust conduits of a fuel cell stack.

2. A fluid management system as claimed in claim 1 wherein the oxidant exhaust conduit is in fluid communication with the separator membrane of the supply conduits and the first liquid water separator comprises a trough located below and spaced from one of the supply conduits, wherein liquid water in an oxidant exhaust stream coalesces in the trough when the oxidant exhaust stream flows through the space between the trough and supply conduit.

3. A fluid management system as claimed in claim 2 wherein the fuel and oxidant supply conduits are hollow thread water permeable tubes.

4. A fluid management system as claimed in claim 3 wherein the fuel and oxidant supply conduits are perfluorocarbonsulfonic acid-based ionomer tubes.

5. A fluid management system as claimed in claim 4 wherein the oxidant exhaust conduit comprises a pair of fluidly coupled and thermally conductive tubes each spaced from and surrounding one of the supply conduits and defining an annular conduit through which the oxidant exhaust stream flows and water vapor in the oxidant exhaust stream permeates through the supply conduits to humidify supply streams flowing therethrough.

6. A fluid management system as claimed in claim 5 wherein the trough is located in a bottom portion of one of the oxidant exhaust conduit tubes.

7. A fluid management system as claimed in claim 6 wherein the first liquid water separator further comprises a water coalescing mesh located in the annular conduit 5 above the trough, the mesh having a mesh size that encourages liquid water to coalesce thereon and allows oxidant exhaust flowing through the trough to permeate upwards through the mesh.

8. A fluid management system as claimed in claim 5 further comprising a coolant conduit in thermal communication with the oxidant exhaust conduit tubes, the coolant conduit being in fluid communication with the fuel cell stack to receive heated coolant therefrom and transmit heat to the oxidant exhaust stream.

9. A fluid management system as claimed in claim 8 wherein the coolant is selected from the group consisting of water and a glycol solution.

10. A fluid management system as claimed in claim 8 wherein the supply and exhaust conduits have a length sufficient for water vapor to permeate from the oxidant exhaust conduit into the oxidant and fuel supply conduits.

11. A fluid management system as claimed in claim 2 wherein the manifold comprises a second liquid water separator that is in fluid communication with the fuel exhaust conduit, and which coalesces liquid water from a fuel exhaust stream flowing through the fuel exhaust conduit.

12. A fluid management system as claimed in claim 11 wherein the second liquid water separator comprises a water coalescing mesh having a mesh size that encourages liquid water to coalesce thereon and allows a fuel exhaust stream to flow through the mesh.

13. A fluid management system as claimed in claim 12 wherein the second liquid water separator has an outlet downstream of the mesh that is fluidly coupled to the manifold, for recirculating at least some of the fuel exhaust stream back to the fuel supply stream.

14. A fluid management system as claimed in claim 13 further comprising a purge valve fluidly coupled to the second liquid water separator outlet and the oxidant exhaust conduit, for discharging at least some of the fuel exhaust into the oxidant exhaust conduit.

15. A method of managing fluids for a fuel cell stack, comprising:
(a) transmitting fuel supply and oxidant supply streams through a humidifier;
(b) receiving fuel exhaust and oxidant exhaust streams from a fuel cell stack and transmitting at least one of the exhaust streams through a first liquid water separator wherein liquid water in the exhaust stream coalesces in the separator; and
(c) transmitting the exhaust stream from the separator and into the humidifier, wherein water vapor permeates from the exhaust stream through a separator membrane and to the fuel supply and oxidant supply streams.

16. A method as claimed in claim 15 wherein the oxidant exhaust stream is transmitted through the first water separator.

17. A method as claimed in claim 16 wherein the first water separator includes a trough, the oxidant exhaust stream is transmitted through the trough, and liquid water in the oxidant exhaust stream coalesces in the trough.

18. A method as claimed in claim 17 further comprising transmitting the oxidant exhaust stream through a water coalescing mesh above the trough such that liquid water in the oxidant exhaust stream coalesces on the mesh.

19. A method as claimed in claim 16 wherein the fuel exhaust stream is transmitted through a second water separator.

20. A method as claimed in claim 19 wherein the fuel exhaust stream is transmitted through a water coalescing mesh in the second water separator such that liquid water in the fuel exhaust stream coalesces on the mesh.

21. A method as claimed in claim 20 further comprising combining at least some of the fuel exhaust stream transmitted through the second water separator with the fuel supply stream.

22. A method as claimed in claim 21 further comprising purging at least some of the fuel exhaust stream transmitted through the second water separator into the oxidant exhaust stream.

23. A method as claimed in claim 15 further comprising receiving a heated coolant from the fuel cell stack then thermally conducting sufficient heat from the coolant to at least one of the supply streams to maintain the temperature of the supply stream at a defined level.

24. A method as claimed in claim 16 further comprising determining the heated coolant temperature when received from the fuel cell stack, then adjusting one or both of the flow rate and temperature of the coolant in order to maintain the temperature of the supply stream at the defined level.
